(19) United States
(12) Patent Application Publication
(10) Pub. No.: US 2006/0173744 A1
(43) Pub. Date: Aug. 3, 2006

(54) Method and apparatus for generating, optimizing, and managing granular advertising campaigns

(76) Inventors: David R. Kandasamy, Palo Alto, CA (US); Eduardo F. Llach, Palo Alto, CA (US)

Correspondence Address: HAVERSTOCK & OWENS LLP, 162 NORTH WOLFE ROAD, SUNNYVALE, CA, 94086, US

(21) Appl. No.: 11/345,135

(22) Filed: Jan. 31, 2006

Related U.S. Application Data
(60) Provisional application No. 60/649,205, filed on Feb. 1, 2005.

(51) Int. Cl. G06Q 30/00

(52) U.S. Cl. 705/14

(57) ABSTRACT

Systems for and methods of the present invention are directed to managing and optimizing ad campaigns. One method in accordance with the present invention comprises selecting a parent advertising campaign and generating a child advertising campaign, wherein the child advertising campaign automatically inherits selected advertising criteria from the parent advertising campaign. Another method in accordance with the present invention comprises determining performance metrics for multiple advertisements in an advertising campaign, selecting an advertisement from the multiple advertisements based on its performance metric, and running the selected advertisement. Performance metrics include, but are not limited to, return on ad spend, conversions, number of clicks on an advertisement, number of purchases, to name a few metrics.

### RELATED APPLICATION

This application claims priority under 35 U.S.C. § 199(e) of the co-pending U.S. provisional patent application Ser. No. 60/649,205, filed Feb. 1, 2005, and titled “Method and Apparatus for Generating, Optimizing and Managing Granular Advertising Campaigns,” which is hereby incorporated by reference.

### FIELD OF THE INVENTION

This invention relates to electronic commerce. More specifically, this invention relates to electronic advertising campaigns conducted on the World Wide Web.

### BACKGROUND OF THE INVENTION

Using keywords, Web-based advertising is able to better target ads to more likely customers. Web-based advertising also allows merchants to track the effectiveness of the ads, by quickly calculating what percentage of users viewing an ad actually click through to the merchant's site. The effectiveness of ads can thus be computed using such marketing metrics as Return on Advertising Spend (ROAS), Cost Per Click (CPC), and the like. Some services, such as Google's™ AdWords®, a pay-per click (PPC) service, let merchants specify which keywords will trigger their ads and the amount they are willing to pay per click. Other services allow merchants to track returns on investment (ROIs). While services exist for generating campaigns and tracking ROIs, no services exist for managing advertising campaigns by controlling multiple criteria of the advertising campaigns.

### BRIEF SUMMARY OF THE INVENTION

The present invention is directed to systems for and methods of managing and optimizing advertising campaigns. In one aspect, a method of managing an advertising campaign comprises selecting a parent advertising campaign and generating a child advertising campaign, wherein the child advertising campaign automatically inherits selected advertising criteria from the parent advertising campaign. Preferably, The advertising criteria include at least one of a keyword, a creative, and a bid. In one embodiment, changing a value of an advertising criterion in the parent advertising campaign automatically triggers a change in a value of the advertising criterion in the child advertising campaign. In another embodiment, the method further comprises setting the parent advertising campaign to trigger on a first type of keyword match and setting the child advertising campaign to trigger on a second type of keyword match.

In one embodiment, each of the first type of keyword match and the second type of keyword match is one of an exact match, a phrase match, and a broad match. In yet another embodiment, the parent advertising campaign is targeted to a first geographical location and the child advertising campaign is targeted to a second geographic location different from the first geographic location. In yet another embodiment, a ratio between a value of an advertising criterion in the parent advertising campaign and a value of the advertising criterion in the child advertising campaign varies with a relationship between the first geographic location and the second geographic location. It will be appreciated that the parent advertising campaign and the shadow advertising campaign are each able to have any combination of advertising criteria, each combination independent of the other.

In a second aspect of the present invention, a method of managing an advertising campaign comprises determining performance metrics for multiple advertisements in the advertising campaign and selecting an advertisement from the multiple advertisements based on its performance metric. Each advertisement is formed by combining keywords, and creatives, wherein each keyword and each creative has an associated rating. In one embodiment, the combining of keywords and creatives is determined by a fallback algorithm. Preferably, the selected advertisement is selected based on a performance metric associated with its match type. The match type is one of an exact match, a phrase match, and a broad match. In another embodiment, the method further comprises adjusting a bid for a keyword based on the match type. In another embodiment, the method further comprises identifying new keywords to be added to the advertising campaign based on the match type. In another embodiment, the method further comprises determining which keywords from a plurality of keywords are to be run in a selected one of an exact match, a phrase match, and a broad match.

In one embodiment, each advertisement has a corresponding combination of creative, match type, landing page, and geographic target. Preferably, the multiple advertisements are run concurrently. Alternatively, the multiple advertisements are run sequentially.

In yet another embodiment, the method further comprises generating a plurality of combinations of advertising criteria for the multiple advertisements. A performance metric of the selected advertisement corresponds to a conversion rate. In one embodiment, the method further comprises adjusting bids based on performance metrics corresponding to each of the plurality of advertising criteria. Preferably, the method further comprises concurrently running the multiple advertisements each containing a keyword and determining a performance metric for each advertisement. Alternatively, the method further comprises sequentially running the multiple advertisements each containing a keyword and determining a performance metric for each advertisement.

In another embodiment, the advertising criteria comprise any one or more of keywords, channels, syndications, creatives, match types, landing pages, geographic areas, days of the week, times of the day, age and gender.

In another embodiment, the multiple advertisements are related in a tree structure having a parent node and corresponding child nodes. The parent node corresponds to an advertisement and the child nodes each corresponds to a match type for the advertisement of the parent node. The method further comprises pruning a child node from the tree if a performance metric corresponding to the parent node is below a predetermined threshold value.

In another embodiment, the advertising criteria correspond to geographic targets, the method further comprising determining a bid for each of the advertisements based on its geographic target and its corresponding performance metric.

In another embodiment, the method further comprises determining sources of actions for each of the multiple advertisements and removing an advertisement from running at a source where a performance metric for the advertisement is below a predetermined threshold value. The sources of actions are identified by Internet Protocol addresses. Preferably, the method further comprises determining a referrer Uniform Resource Locator containing an Internet Protocol address.

In another embodiment, the method further comprises specifying multiple performance goals for the multiple advertisements and adjusting bids for the multiple advertisements based on the multiple performance goals. The performance goals comprise a maximum total cost for the entire advertising campaign and a maximum cost for an advertisement in the advertising campaign.

In another embodiment, the method further comprises determining a first keyword for the advertising campaign, automatically determining a negative keyword of the first keyword, and running an advertisement from the advertising campaign only if a document that triggers the advertising campaign contains the first keyword but does not contain the negative keyword. The negative keyword is determined from at least one of search terms and conversion data.

The method further comprises determining a sequence of clicks for accessing an item through an advertisement in the advertising campaign, determining a value for the clicks in the sequence of clicks, and allocating a performance metric to each of the clicks in the sequence of clicks. Preferably, allocating performance metrics is based on any one or more of a time of a click, an order of a click in the sequence of clicks, and a number of advertisements clicked.

In a third aspect of the present invention, a shadow campaign system comprises means for generating a shadow campaign from a parent advertising campaign and means for populating the shadow campaign with selected advertising criteria from the parent advertising campaign. The shadow campaign module is configured so that its advertising criteria are capable of being set manually. In yet another embodiment, the shadow campaign is a selected one of a conditional shadow campaign and an unconditional shadow campaign.

In a fourth aspect of the present invention, a system for managing an advertising campaign comprises a first module for generating multiple advertisements each containing a combination of advertising criteria from multiple combinations of advertising criteria and a performance calculator for calculating a performance of an advertisement from the multiple advertisements. The advertising criteria comprise any two or more of geographic locations, traffic sites, and match types. Alternatively, the advertising criteria comprise any two or more of creatives, landing pages, and geotargeting criteria. Alternatively, the advertising criteria comprise any two or more of keywords, channels, syndications, days of the week, and times of the day.

In another embodiment, the system further comprises a run module for running the generated multiple advertisements. The run module is configured to run the generated advertisements concurrently. In some embodiments, the run module invokes a system that displays advertisements. In other embodiments, the run module displays the advertisements itself. Alternatively, the run module is configured to run the generated advertisements sequentially.

In another embodiment, the system further comprises means for pruning advertisements that do not meet a threshold performance metric. In yet another embodiment, the system further comprises means for determining a purchase of an item from an advertisement in the advertising campaign and means for determining performance metrics for clicks in a sequence of clicks leading to the purchase. The means for determining performance metrics is configured to analyze a time of the clicks in the sequence of clicks, an order of a click in the sequence of clicks, and a number of clicks in the sequence of clicks.

### BRIEF DESCRIPTION OF THE SEVERAL VIEWS OF THE DRAWINGS

FIG. 1 is a high-level block diagram showing several components of one embodiment of the present invention.

FIG. 2 shows a parent and its corresponding shadow campaign in accordance with the present invention.

FIG. 3 shows the steps for creating a parent and its corresponding ad campaign in accordance with the present invention.

FIG. 4 shows steps used to optimize the performance of an advertisement in an advertising campaign in accordance with the present invention.

FIG. 5 is a table mapping types of keywords to ratings that are sequentially paired against the keywords using an algorithm in accordance with the present invention.

FIG. 6 shows ads run using sequential pathing in accordance with the present invention.

FIG. 7 is a table showing the number of paths generated based on specified criteria in accordance with the present invention.

FIG. 8 shows nodes in a tree depicting ads in an ad campaign in accordance with the present invention.

FIG. 9 is a high-level diagram of components for generating and running advertisements in accordance with the present invention.

FIG. 10 shows steps for creating an advertising campaign in accordance with the present invention.

FIG. 11 is one example of a weekly performance report generated in accordance with the present invention.

FIG. 12 is a table showing statistics used to optimize an ad campaign in accordance with the present invention.

### DETAILED DESCRIPTION OF THE INVENTION

Embodiments of the present invention are used to effectively manage and optimize very fine grained advertising campaigns, such as those created for Search Keywords and Contextual Advertising. As used herein, a granular advertising campaign is one in which an ad is targeted to a small number of impressions and the results are measurable in impressions/clicks and back-end transactions. As used herein, an impression is any display of an ad. Preferably, ads are interactive so that a prospective customer can “click,” access, or otherwise interact with the ads, thereby triggering the generation of a report on the actions of the prospective customer. This occurs on the World Wide Web, and it can also occur on cellular phones, wireless devices, interactive TV, interactive kiosks, and connected personal digital assistants (PDAs), to name a few devices.

Embodiments of the present invention are used to effectively create, optimize, or both, large, complex and very granular advertising campaigns. In accordance with one embodiment of the present invention, campaigns are managed using shadow campaigns, also called hierarchically related campaigns. In accordance with this embodiment, a sub-campaign is targeted to a subset of the overall universe of possible impressions. Because the result of each shadow campaign is able to be tracked, rules are able to be generated for controlling how the shadow campaign is set in relation to the parent campaign.

Also in accordance with the present invention, keywords and creatives are used to manage an advertising campaign. As used herein, a creative consists of information used to display and manage an ad. This includes, for example, a title, description, display, click-through rate, keywords, and their associated bids. Keywords and creatives are matched and metrics for each combination are generated. The best performing combination is then selected for display. Of course, the best-performing combination is able to be changed based on, for example, changing goals, changing product descriptions and prices, and changing business environments.

Also in accordance with the present invention, ad campaigns are managed by tracking and analyzing match types. As used herein, a match type is the type of match that must occur before an ad is displayed. In some embodiments, a match type is any one of a perfect or exact match; a phrase match; and a broad match, types all well known in the art. In accordance with these embodiments, when an ad is displayed is determined by the targeting (e.g. keyword or content category) and the type of matching being used for matching the ad target with the impression's classification. If the matching is exact then the ad will show only if the impression's classification exactly matches the ad's target. If the matching is broad, rules are used to determine what ads can show on which impressions.

In accordance with other embodiments of the present invention, negative keywords are automatically generated. For example, for “broad” and “phrase” match types, negative keywords are automatically generated based on analysis of search term information in the conversion data, that is, data indicating when the display of an ad results in a user accessing it.

In accordance with yet other embodiments of the present invention, as campaigns are managed by performing sequential pathing. In these embodiments, when an ad network does not support separate and concurrent instances of a keyword within a campaign and comparisons between trial creatives are not possible, trials are run sequentially.

Other embodiments of the present invention are directed to optimizing ad campaigns. In one of these embodiments, keyword paths (e.g., “local paths”) are optimized. In these embodiments, each keyword, creative, channel, match type, syndication and several other factors governing where and how an ad is displayed creates a path or a distinct combination of variables. Optimization is determined across all the possible combinations. Determining how to reinforce or reduce a particular path's strength depends on a number of factors.

In accordance with other embodiments of the present invention, ad campaigns are optimized by performing global optimization. In these embodiments, performance targets (e.g., Return on Ad Spend or “ROAS” targets) are set at each of the Product/Category, Campaign, Ad group, and Keyword/Creative levels within the overall campaign hierarchy. When a target is set at a certain level, optimizations for each descendent level are automatically computed to achieve the target.

In yet other embodiments, campaign ads are optimized by pruning keyword paths. In these embodiments, to keep the total number of keywords within technological and practical limitations, the overall campaign structure is selectively pruned based on analysis of performance metrics at each level of the hierarchy. The overall number of keywords can be set to a user specified arbitrary maximum for each campaign.

In yet other embodiments, campaign ads are optimized by analyzing geographic data. A nationwide campaign is divided into metro areas. The performance of each Keyword Path at the metro level is measured and then bids are made accordingly.

In yet other embodiments, campaign ads are optimized by analyzing traffic sites. The performance of traffic from each publisher site is tracked and sites are removed from syndication if it fails to meet some metric or falls within some designated number/fraction of the lowest performing sites.

In yet other embodiments, campaign ads are optimized by optimizing multiple targets. In these embodiments, multiple target constraints are specified. These include a Cost Per Order constraint as well as a monthly budget.

In yet other embodiments, campaign ads are optimized by optimizing purchasing funnels. Users typically see and click on multiple ads before making a purchase. In these embodiments, the contribution of earlier clicks toward the ultimate purchase are calculated and attributes value from each purchase to their early (“head”) terms.

Embodiments of the present invention are thus directed to campaign management, optimization, and reporting. The embodiments incorporate “glue logic” to interface with many of the ad networks and tracking systems, and simplify the view of the ad campaign to an administrator while internally building a complex campaign structure to fully use all available targeting mechanisms provided by ad networks.

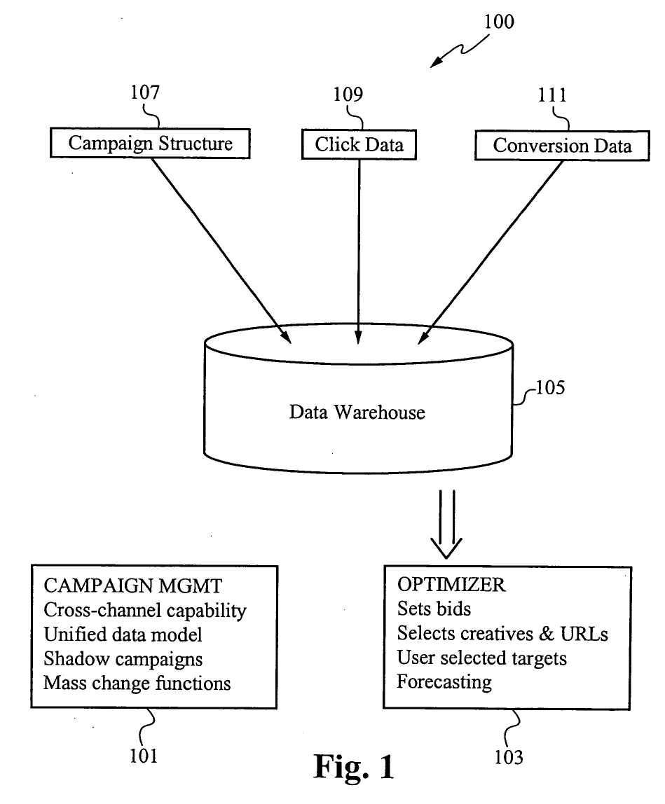

FIG. 1, for example, shows a high level diagram of one system 100 in accordance with the present invention. The system 100 comprises a campaign management module 101 and an optimizer module 103 both coupled to a data warehouse 105 that contains a campaign structure 107, click data 109, and conversion data 111. The campaign structure 107 is used to define and manage an ad campaign; the click data 109 is used to track click-through data and the like; and the conversion data 111 is used to track conversions. To simplify the discussion that follows, the term “management” is used to refer to modules that are able to manage, or optimize, or both campaign advertisements.

Campaign Management

Shadow Campaigns

Shadow campaigns are a way of making new, dynamic copies of campaigns and changing some small portion of the new campaign. They are particularly useful for geographic targeting, as well as syndication level and match type discrimination.

A shadow campaign works as follows: First, a parent campaign is identified, and a shadow (e.g., child) campaign is generated and a name is assigned to it. Next, all keywords and creatives from the parent campaign are duplicated in the shadow campaign. Bids from the parent campaign are multiplied by a specified ratio to generate the equivalent bids in the shadow campaign. The match type in the shadow campaign is selectively set to a value equal to or different from that in the parent campaign. As one example, the parent campaign is set to Phrase match for all keywords, while the shadow may be set to Broad match.

Later, any changes made in the parent (e.g. adding new keywords or modifying creatives) are reflected in the shadow unless the corresponding entity has been changed in the shadow campaign. For example, if the creative has been modified in the shadow campaign first, then changing that creative in the parent campaign will not result in a change in the shadow campaign.

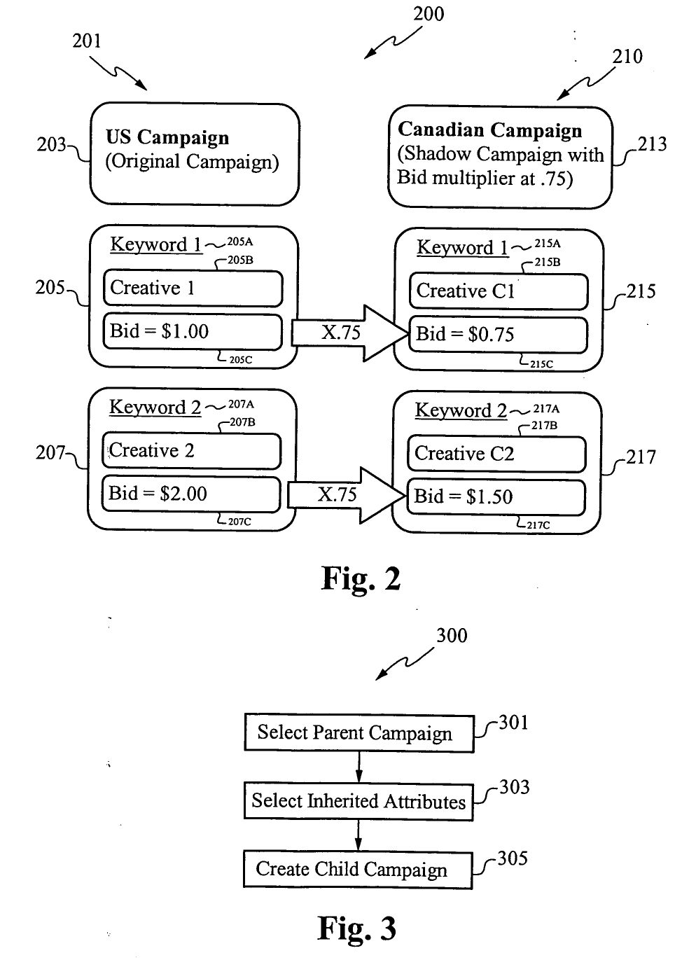

Preferably, bid ratios are considered to be dynamic. For example, if the shadow is set to have 75% of the bid of the parent, then when the bid of the parent is updated, the bid of the shadow is updated to be 75% of that. On the other hand, if the bid for a keyword is manually set to a particular value, then changing the bid in the parent will not update the bid in the shadow. One example of an application for this would be in creating a Canada-targeted campaign (the shadow campaign) from a US campaign (the parent campaign), as shown by the campaign family 200 in FIG. 2. The campaign family 200 shows a U.S. campaign (e.g., parent campaign) 201 having (1) a title “US Campaign” 203, (2) a first keyword block 205 titled “Keyword1” 205A having a Creative 1 205B and a bid 205C, and (3) a second keyword block 207 titled “Keyword2” 207A having a Creative 2 207B and a bid 207C. The US campaign 201 has a Canadian shadow campaign 210, having (1) a title “Canadian Campaign” 213, (2) a first keyword block 215 copied from the first keyword block of the US campaign 205, titled “Keyword1” 215A having a Creative C1 215B and a bid 215C that is 75% of that of the corresponding bid in the first keyword block of the US campaign 205C and (3) a second keyword block 217 copied from the second keyword block of the US campaign 207, titled “Keyword 2” 217A having a Creative C2 217B and a bid 217C that is 75% of that of the corresponding bid in the second keyword block of the US campaign 207C.

In addition to changes to the creative, the bids in the Canadian campaign are set to 75% of US bids by default. One advantage of this scheme is that keywords are added to the US campaign are automatically added to the Canadian campaign.

It will be appreciated that the shadow construct is able to be applied to any level of a campaign hierarchy. Some embodiments of the present invention support Shadow Products/Categories, Campaigns and Ad Groups.

FIG. 3 shows steps 300 for generating a shadow campaign from a parent campaign in accordance with embodiments of the present invention. First, in the step 301, a parent campaign is selected and, in the step 303, the inherited attributes to be copied to the shadow campaign are selected. In the step 303, factors such as bid multipliers are also determined. In the step 305, the shadow campaign is then determined.

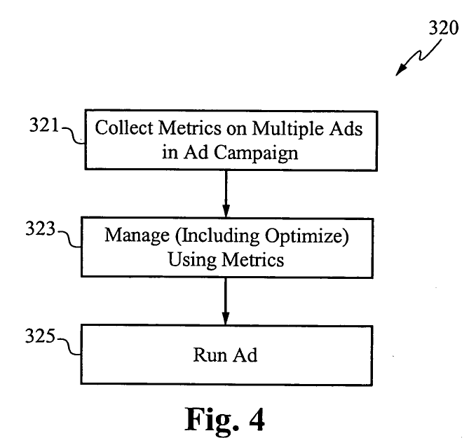

FIG. 4 shows a sequence 320 of steps for managing an advertising campaign in accordance with the present invention. In the first step 321, performance metrics are collected for multiple advertisements in an advertising campaign. Performance metrics include, but are not limited to, Return on Ad Spend (RAOS), cost per action, number of actions, return on investment (ROI), revenues, or any other metric for measuring the performance of an advertisement or advertising campaign. Next, in the step 323, the advertising campaign is managed, such as by creating advertisements to be run or optimizing advertisements. Finally, in the step 325, a selected one or more advertisements are run.

In another embodiment, a parent campaign is a superset of a shadow campaign. This parent and shadow relationship has advantages, especially for keyword path pruning, described in more detail below. As one example, a parent campaign is a US-wide campaign and has New York and Los Angeles shadow campaigns. In the event a given keyword is low volume, resulting in the shadow campaigns being pruned, the parent campaign is still able to cover the New York and Los Angeles metro areas with the nationwide campaign.

Keyword and Creative Ratings

In accordance with other embodiments, ad text affects click-thru rate (CTR) and conversion rate/ROI (CVR). For example, the ad “Free film processing, free shipping” will probably have a higher CTR and a lower CVR than the ad “24 cents per print with archival quality paper.” The first ad text or creative is called “aggressive” because it mentions the word “free,” and the second ad text or creative is called “conservative” because it mentions a price.

As used herein, a “creative” refers to information for creating and tracking an advertisement, such as a title of an advertisement, a description, a display, a click-through URL, keywords, and bids.

Depending on the keyword, it may be determined to run an aggressive creative against it. An aggressive creative will maximize traffic but also maximize ad spend. Embodiments of the present invention allow a campaign manager to specify a rating for each keyword and each Creative. Thus, if a keyword is rated aggressive and an aggressive-rated creative is available, the keyword and creative will be paired together.

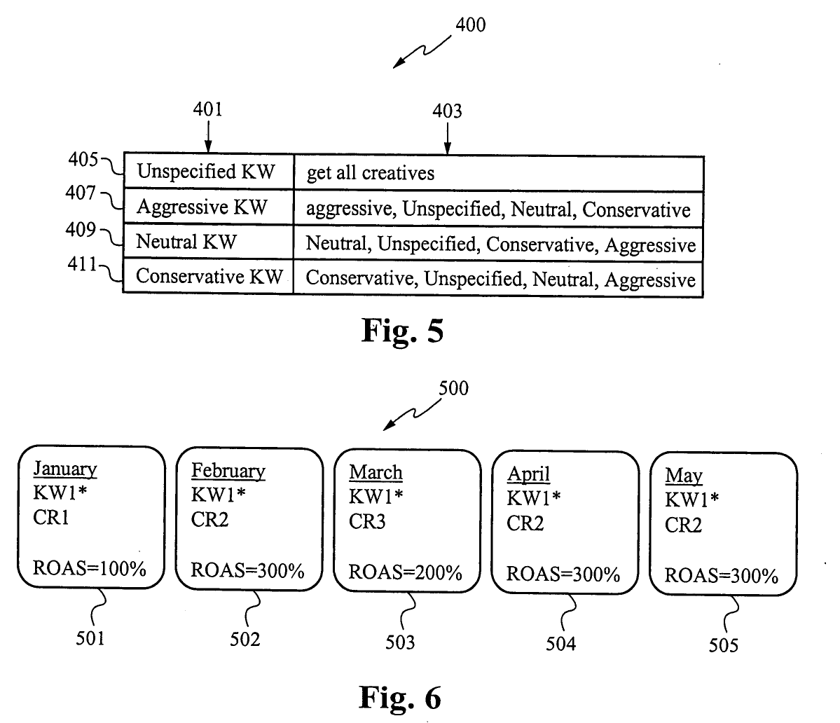

When no exact ratings match exists, a fallback algorithm such as illustrated in the table 400 shown FIG. 5 is used. The table 400 contains rows 405, 407, 409, and 411 in which entries in the column 401 indicate a type of rating for a keyword (KW) and the entries in the corresponding column 403 indicate the fallback algorithm. For example, the row 405 contains entries that indicate when a keyword is unspecified (column 401), using the algorithm, all creatives are used (column 403). The row 407 contains entries that indicate when a keyword is aggressive (column 401), using the algorithm, it is first paired with an aggressive creative; if no aggressive creative exists, it is paired with an unspecified creative; if no unspecified creative exists, it paired with a neutral creative; if not neutral creative exists, it is paired with a conservative creative (column 403), in that order. The row 409 contains entries that indicate when a keyword is neutral (column 401), using the algorithm, it is first paired with a neutral creative; if no neutral creative exists, it is paired with an unspecified creative; if no unspecified creative exists, it paired with a conservative creative; if not conservative creative exists, it is paired with an aggressive creative (column 403), in that order. The row 411 contains entries that indicate when a keyword is conservative (column 401), using the algorithm, it is first paired with a conservative creative; if no conservative creative exists, it is paired with an unspecified creative; if no unspecified creative exists, it paired with a neutral creative; if not neutral creative exists, it is paired with an aggressive creative (column 403), in that order.

Match Type Analysis

Some embodiments of the present invention use two techniques for optimizing ad campaigns to take advantage of Match Types. In these embodiments, particularly those that run on Google, the same keyword is run in multiple campaigns three ways (i.e. once with each Match Type). The keyword is run only once, in Broad match. A tracking system identifies the actual search term typed in at run time (e.g. using the Referrer information from the HyperText Transfer Protocol or “HTTP”) and tracks return on investment (ROI) for each actual search term. The accumulated search terms (and their results) are then grouped into whether they are Exact, Phrase or Broad matches for the keywords in the ad campaign. The ad spend, revenue and conversion rate are then able to be identified for each match type per keyword. Match Type information is then able to be used to adjust bids, and also to identify new keywords to be added to the campaign, or which existing keywords should be explicitly run in Exact or Phrase match mode.

Negative Keyword Auto-Generation

When “broad” or “phrase” keyword matching is used with a channel, it is often necessary to use negative keywords to more appropriately contextualize the ad placement. For example, a vendor of women's shoes may bid on the keyword “shoe.” However, “broad” or “phrase” matching may place that ad with keyword phrases such as “brake shoes” or “horse shoe.” Specifying “brake” or “horse” as negative keywords ensures that the vendor's ads do not appear in such undesirable contexts.

Negative keywords are often hard to foresee. Negative Keyword Auto-Generation evaluates actual search terms derived from traffic and conversion data and based on its analysis will determine which search terms should be included as a negative keyword.

Sequential Pathing

With certain optimization processes, it is desirable to run the same keyword(s) with variations in the creative, match type, landing page (the Web page that a customer first encounters when he accesses a Web site, which, may be different from the site's home page) or geotargeting criteria in multiple concurrent trials. Optimizations of the campaign are then able to be fine tuned based on comparisons of the performance of each trial. However, when a channel does not support concurrent trials with the same keyword(s), these trials will be run sequentially rather than concurrently. The timing and sequence of the trials are managed to produce comparable results.

As one example, if three creatives are relevant to a particular keyword, they are able to be run, one at a time, over three consecutive months. The results are then able to be analyzed to determine which one is selected. Preferably, the other two creatives are automatically run periodically (e.g. one week every quarter) as user behavior changes over time.

FIG. 5 shows a sequence 500 of paths 501-505 that are run sequentially, in accordance with the present invention. The path 501, run in January, is for a keyword KW1*, using a creative CR1 and a target Return on Ad Spend (ROAS) of 100%. Next in sequence, a path 502, run in February, is for a keyword KW1*, using a creative CR2 and a target ROAS 300%. The paths 503-505 have parameters with values that are similarly explained.

Optimization

Keyword Path (Local) Optimization

Keyword Path Optimization refers to taking into account a multitude of factors in determining the selection of bids, keywords, and creatives. All sensible combinations are enumerated, the return on investment for each combination is measured, and bids are priced accordingly. The several factors include, but are not limited to, channels, syndications, keywords, and channels, each discussed in turn.

Channels: Generally, each channel has different bid prices for the same keyword. For example, the bid price for a keyword on Google will be different than the bid price for the same keyword on Overture.

Syndications: Particularly for Google, it is possible to bid and measure performance separately for Google.com, Search Partner, and Content Partner traffic. Yahoo (Overture) allows separation by Search vs Content site traffic.

Keywords: Bids and performances vary for each keyword. Even misspellings and plurals can have dramatic performance differences.

Creatives: Wherever possible multiple ads should be run and each should be treated as a separate combination.

Match Type Optimization: Match Types are constructs used by search advertising networks to increase the distribution of campaigns without having to exhaustively specify all matching keywords. One embodiment of the present invention runs each keyword in each of the Match Types and calculates the appropriate cost per click (“CPC”) bid for each variant.

Syndication Optimization: The ad networks are literally networks of hundreds or thousands of Web sites. In an ideal world the performance of the traffic from each individual Web site would be measured and bid for. This is not always possible but broad groupings are made available, such as search sites and content sites.

Date/Time Optimization: This optimization measures the performance of the campaign based on recent Mondays, Tuesdays, etc. and adjusts bids en masse accordingly.

Landing Pages Optimization: For clients having multiple potential landing pages, all are preferably used and measured.

Keyword Path Optimization can be truly local. In accordance with one embodiment, only one path is viewed and optimized without regard to any other path. In accordance with other embodiments, Keyword Path Optimization is also extended to related paths, such as when optimizing all the paths derived from a single keyword.

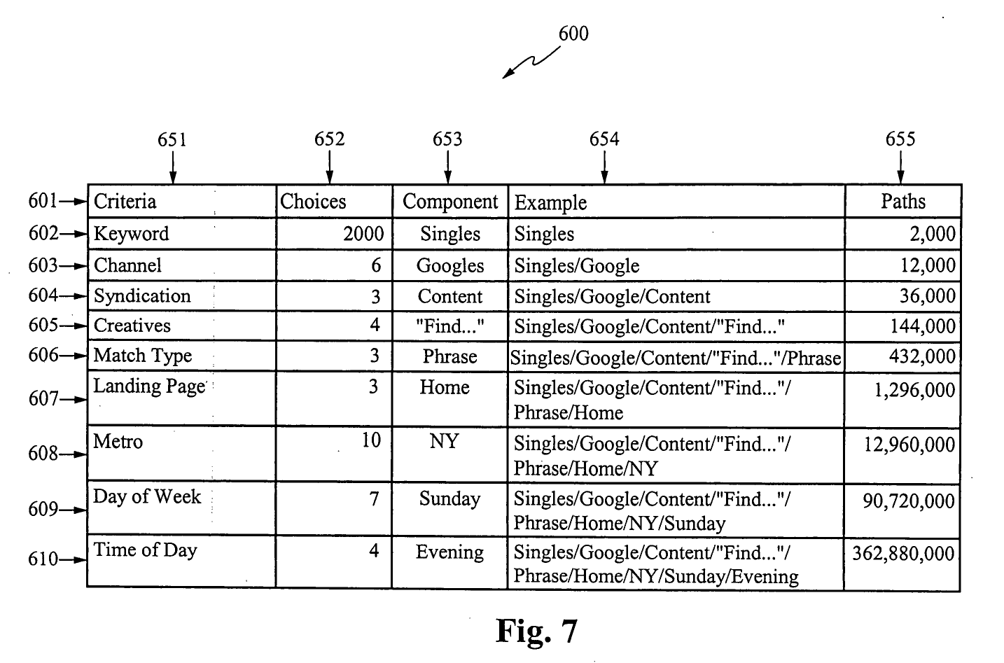

FIG. 7 shows a table 600, illustrating the number of paths for a typical campaign in accordance with one example. The table 600 contains rows 601-610 and columns 651-655. Each column 651-655 is labeled to indicate the type of entry in the column. Entries in the row 601 are headings to describe what the values in a particular column indicate. Thus, for example, the column (651) labeled “Criteria” contains entries for each criteria describing a portion of an ad campaign, such as a “keyword” (row 602) and a “channel” (row 603). The column (652) labeled “Choices” indicates the number of choices for the particular criteria. Thus, for example, the row 602 is for the “keyword” criteria (column 651), which has 2,000 choices for this example (column 652), has the component “Singles” (column 653), given by the example “Singles” (column 654), and thus has 2,000 associated paths (column 655). Similarly, the row 603 is for the “channel” criteria (column 651), which has 6 choices for this example (column 652), has the component “Google” (column 653), given by the example “Singles/Google” (column 654), and thus has 12,000 associated paths (column 655), determined by multiplying the 2,000 choices for the “keyword” criteria with the 6 choices of the channel criteria. The remaining examples are similarly explained.

Global Optimization

Global Optimization refers to the setting of performance targets at a higher level, and adjusting the targets of deeper campaign entities in a way to best achieve the higher level targets. As one example, an entire account is to be optimized to a 200% ROAS. (This is also referred to as a portfolio-level target.) In a simple-minded case, the global optimizer would want every product/campaign/ad group to perform at the 200% level.

However, since some campaigns (e.g. those containing Branded terms) may always perform at better than 200%, the others may only need attain 180% ROAS for the portfolio to achieve its goal.

Similarly, though a keyword-level goal of 200% may be set, for whatever reason a keyword may consistently perform at 150%. Thus, to get to the 200% real goal, a target goal of perhaps 250% may be necessary. The Global Optimizer thus needs to adjust target goals to achieve real-world goals.

Keyword Path Pruning

The process of optimization requires that keywords be replicated across channels, campaigns, and syndication levels, each with variations in the creative, match type, and bid. Enumerated in a flat text file with a separate row for each variation of each parameter of each keyword, the number of line items can quickly exceed the practical and technical limits of what an ad network will allow.

As one example, Google has a 100,000 row limit on campaign definitions. As detailed in the table 600 of FIG. 7, it can be seen that expanding the paths for match type, metro area, day of week and time of day could cause campaigns to exceed this limit. Therefore it is necessary to restrict the total number of paths.

As one solution, Keyword Path Pruning analyzes the traffic and conversion data and expands or prunes the Path tree based on whether there are enough conversions to make dividing the bucket still meaningful and also whether there is any benefit to be gained from the division. Here, the term “Path tree” refers to a tree structure in which nodes refer to an advertisement, where some nodes (“child nodes”) are created by adding advertising criteria to “parent nodes.”

As one example of a rule of thumb, if a node in the tree has only 10 conversions over the past month, it may be determined that it should be split further. As another example, it is decided not to perform a Match Type split (that is, have the same keyword in Exact, Phrase and Broad match forms in the campaign) if the analysis shows that the conversion rate is similar for all three match types for this keyword. In such a case, the keyword is run in Broad Match mode.

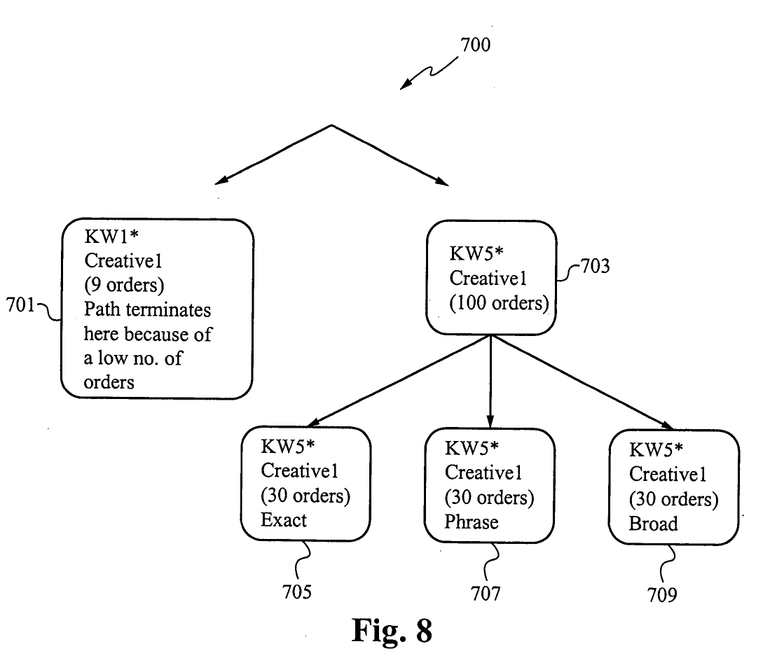

FIG. 8 shows a tree 700 used to describe one embodiment of the present invention. The tree 700 contains a node 701 and a node 703. The node 701 is for a keyword KW*, which has a creative “Creative 1” for 9 orders. The path terminates at the node 701 because the number of orders for this ad campaign (9) is below a predetermined threshold.

In contrast, the node 703, for a keyword KW5*, with a creative “Creative 1,” has 100 orders. Therefore the path does not terminate there; instead, the node 703 has three children nodes, 705, 707, 709, with parameters as indicated in FIG. 7.

Geographic Analysis

Similar to the Match Type analysis feature, a geographic analysis is able to be done on results. This is also done in Explicit and Implicit modes. In explicit mode, separate campaigns are created and targeted to specific countries or metro areas depending on what the ad network provides for targeting capability. In implicit mode, the Internet protocol (IP) address of the referrer or the IP address of the user is able to be used to reverse-locate the source. The source is able to be reverse located using any number of means including, but not limited to, reverse-IP addressing.

Traffic Site Analysis

By examining the IP address of incoming traffic, the tracking system built into the advertiser's Web site is able to identify click source sites. The conversion performance by source site can then be analyzed.

This data is then used two ways: (1) Low performing sites are identified and excluded from the list of sites used. (2) Because some ad networks allow for the specification of different CPC bids by site, the CPC is set to a value commensurate with the sites conversion behavior.

Multiple Optimization Targets

It is possible for a client to specify multiple performance goals or constraints. These are typically Budget and ROI based. For example “optimize the bids down so that we don't spend more than $30K total this month or $10 in advertising per order—whichever is lower.” Sometimes the user wants “whichever is higher” instead.

Purchasing Funnel Optimization

If a customer is looking to buy a new television, he or she might search on the term “color tv” first, then “plasma tv”, then “sony tv” then “sony kvm4542” and then click on ads on each results page before making a purchase.

Optimization systems typically attribute the entire value of the purchase to the last ad clicked. In accordance with the present invention, the value between the multiple ads clicked are apportioned based on a variety of factors including: How recently the ad was clicked; the order of the clicks; and the number of ads clicked.

The objective is to properly increase the value of the early “head” terms and appropriately decrease the value of the later “tail” terms.

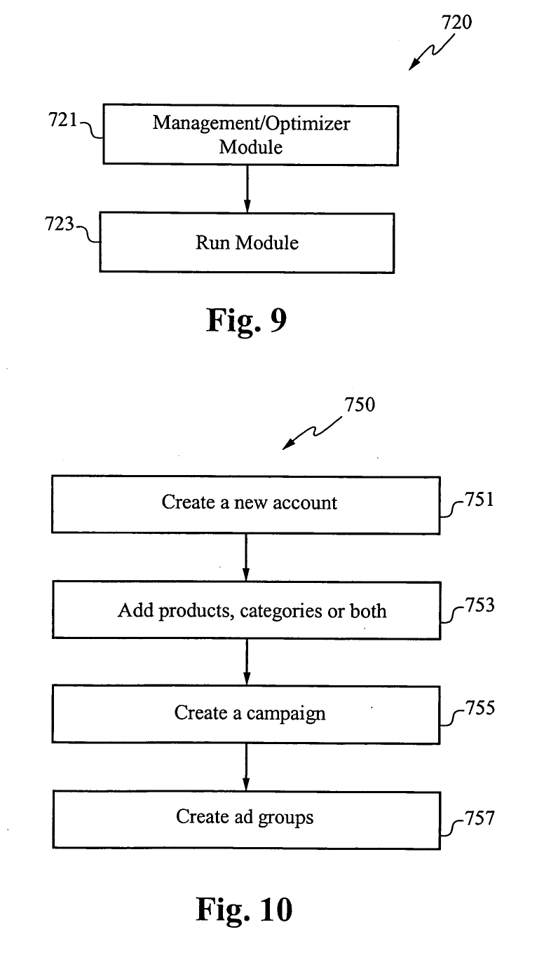

FIG. 9 is a high-level diagram of a system 720 in accordance with the present invention. The system 720 comprises a management module 721 coupled to a run module 723. Here, management is defined broadly to include managing and optimizing advertising campaigns, to fit the application at hand.

In operation, embodiments of the present invention make use of hierarchy and inheritance. Elements such as bids and targets are able to be set at a high level and then inherited. Alternatively, any inherited value is able to be explicitly overridden by setting the value at a lower level of the path tree as desired.

In one embodiment, the data hierarchy is, in decreasing order:
Account: many accounts are able to be handled as needed.
Channel: Each ad network is able to be viewed independently, or the entire view across all channels are able to be summed together.
Category/Product: Using this level, a campaign is able to be subdivided into arbitrary units that represent meaningful divisions to a business. These units include lists of products.
Campaign/Target: At this level, geotargeting (both country and metro) is performed, as are shadow campaigns.
Ad Group: A common list of related keywords that are shown a common set of creatives.
Keywords and Creatives.

FIG. 10 shows a sequence of steps 750 for creating an ad campaign in accordance with the present invention. First, in the step 751, a user creates a new account. In this step, for example, when search and content target campaigns are created, they will default to ratios based on the bids in a parent ad campaign.

In the step 753, products, categories, or both are selected for adding to the ad campaign and used, in the step 755, to create the ad campaign. In the step 753, product and categories are given meaningful names and maximum bid costs per click are both selected. Campaigns are created in the step 755 such as by using Google's AdWords. In one embodiment, the first letter in a campaign name is the syndications level (e.g., G, S, C as in Google, Search, and Content) and the second letter is the match type (e.g., X, P, B as in Exact, Phrase, and Broad). The remaining letters are the geo-targeting information. Thus, for example, “SBUS+CA” refers to a Broad search with the United States and Canada as the targets. Metro-level campaigns are conditional shadow campaigns. The SBUS+CA campaign is the parent campaign, which is able to be manually modified.

Next, in the step, ad groups are created for the ad campaign. Ad groups are able to be created on all channels. Ad groups are able to have multiple creatives, which are able to be run either concurrently or sequentially. Embodiments of the present invention select the highest performing creative for each keyword and run it.

Many ad campaign systems place a limit on the size of ad campaigns. Embodiments of the present invention are used to limit campaign sizes by, for example, using a conditional shadow campaign (CSC). CSCs are shadow campaigns that are only created when a predetermined number of conversions for its parent campaign are made. Such selective creation of shadow campaigns is similar to pruning, described above.

Embodiments of the present invention also include a reporting feature, which is able to produce periodic reports to show ad performance on calendar weekly, monthly, quarterly, or annually, or day-of-week reports to show ad performance by day of the week. These reports allow ad owners to determine which ad campaigns are worthwhile keeping and which should be replaced. Some statistics included in the reports are
Return on Ad Spend (ROAS), which is revenue divided by media spend, that is, how many dollars in tracked revenue were generated by each dollar in ad spend.
Cost per action, which is the dollars in ad spend for each tracked action. The action varies for each client.
The number of actions tracked during the reporting period.
Average Individual Order, which is the total dollars in revenue divided by the number of orders.
Cost per order, which is the total ad spend divided by the number of orders.
The total number of orders during the reporting period.
The order rate, also referred to as the conversion rate, which is the total number of orders divided by the total number of clicks.
The total number of campaign clicks during the reporting period.
The revenue, or total number of dollars tracked during the reporting period.
Costs, or the total ad spend during the period.

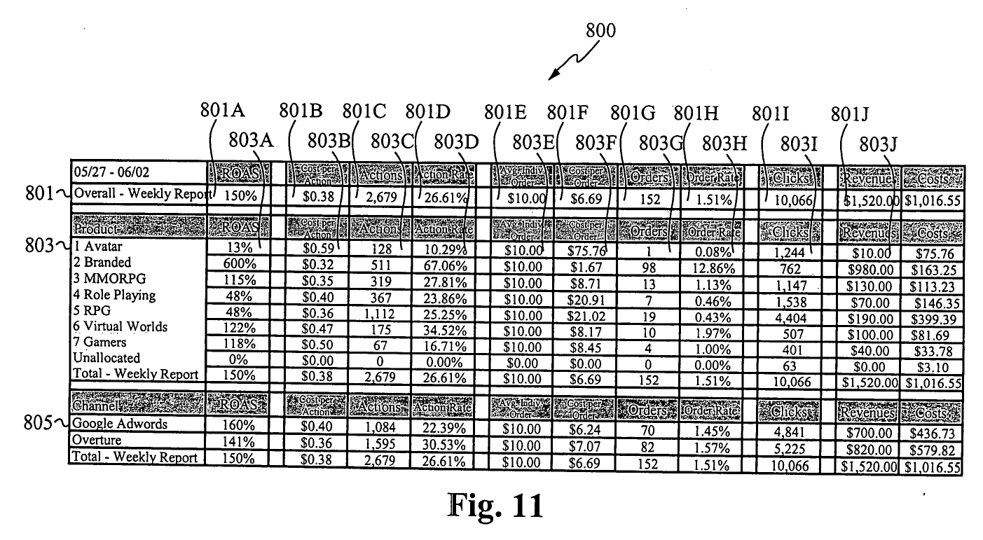

FIG. 11 shows a table 800 of a weekly report in accordance with one embodiment of the present invention. The table 800 contains a row 801 detailing a weekly report for the performance of all products in the ad campaign, a row 803 that details the performance of a single product, “Avatar,” and a row 805 showing similar performance metrics for the channel Google Adwords. As used herein, a channel is an ad network such as Google, Overture, and Enhance. The row 801 has entries 801A-801J and the row 803 has entries 803A-803J, defined by the headings over each column. For example, the row 801 shows that all products together had an ROAS of 150% (entry 801A), a cost per action of 38 cents (entry 801B), had 2,679 actions (entry 801C), a 26.61% action rate (entry 801D), averaged $10 for each order (entry 801E), resulted in $6.69 for each order (entry 801F), resulted in 152 orders (entry 801G), had a 1.51% order rate (entry 801H), had 10,066 clicks (entry 801I), and generated $1,520.00 in revenue (entry 801J). The entries 803A-J show corresponding values for the single product “Avatar.”

In accordance with the present invention, target values and types are able to be set. Target types include (1) ROAS, where the target value is percentage; (2) Rank, or the average position of an ad in relation to competitors's ads; (3) Cost per order (CPO), where the target value is in dollars and cents; (4) Cost per action; (5) Cost per orders and actions (CPOA), where the system looks first to order and, if there are insufficient orders, checks whether there have been enough actions in a predetermined period. If there have been enough actions, the system translates the actions into orders by using the overall action-to-order ratio for the product and category and optimizes the resulting number of orders; and (6) OFF, whereby any optimization for an entity and its descendants is turned off.

Target sets in accordance with the present invention represent the marginal goals on a per-keyword path basis. For example, if a cost per order is set at $10, the optimizer should pay no more than $10 for the most expensive order. Overall campaign performance may deviate from the target is, for example, certain paths (e.g., “branded” terms) are so high performing that even at the top position they exceed the target, based on its return on investment (ROI). In other words, paying more for an order will not produce more orders. Thus, the ROI is above the target, such that as the ROAS increases, the CPO or CPOA decreases. As a second example, a large set of keywords may have produced no orders but individually have not generated enough traffic to allow them to be bid down or disabled.

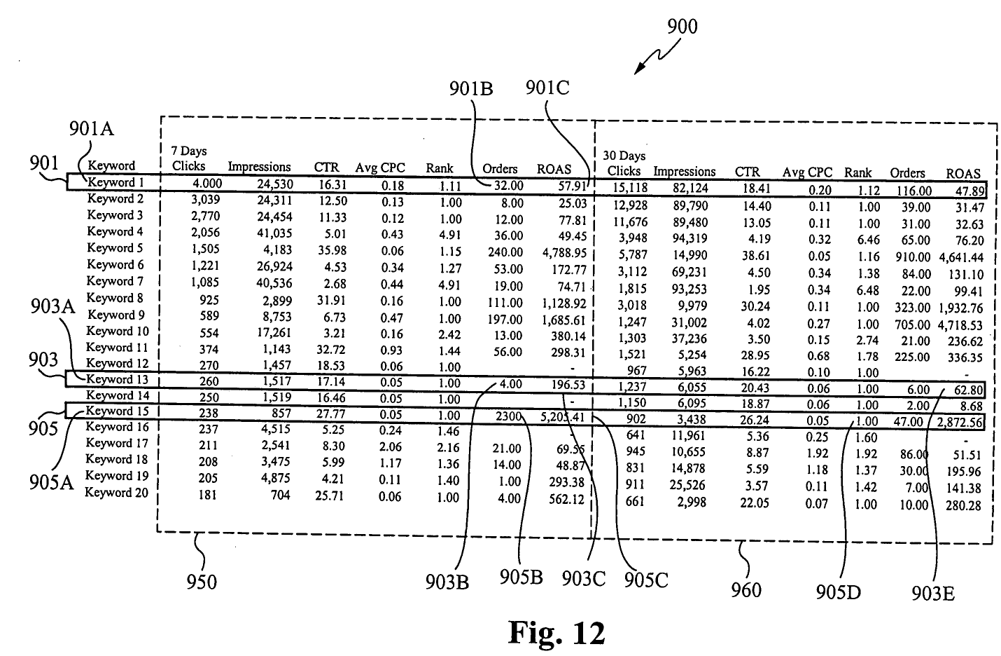

FIG. 12 shows a table 900 showing metrics for keywords used in a campaign managed in accordance with the present invention, used to explain how the campaign is optimized. The hypothetical target ROAS for this example is 100. The table 900 contains the rows 901, 903, and 905, each showing statistics for keywords in entries 901A, 903A, and 905A, respectively. The table 900 is divided into statistics over a 7-day period 950 and over a 30-day period 960, as described below.

The row 901 shows that ads for the “keyword 1” (entry 901A) has resulted in 32 orders (entry 901B) over a 7-day period, with a corresponding ROAS of 57.91 (entry 901C). Because the number of orders over a 7-day period exceeds a pre-determined threshold, statistics from the 7-day potion of the chart are used. Because the ROAS (57.91) is much smaller than the hypothetical ROAS of 100, the bid for this keyword is reduced, such as by 40%. The row 903 shows that ads for the “keyword 13” (entry 903A) has resulted in 4 orders (entry 901B) in the 7-day period, a value below the pre-determined threshold, so statistics from the 30-day portion 960 of the table are used to allow a large enough sampling to provide meaningful data. The ROAS listed in the 30-day (entry 903E) is 62.8, again much smaller than the hypothetical ROAS of 100, so the bid for this keyword is again reduced, such as by 40%. The row 905 shows that ads for the “keyword 15” (entry 905A) has resulted in 23 orders (entry 905B) in the 7-day period, a value above the pre-determined threshold. The corresponding ROAS (entry 905C) is 5,205.41 is high, but the weekly increase has been limited to 100% the maximum value. However, because the rank of the ad is already 1 (entry 905D), no increase is needed.

In operation, a user creates an advertising campaign. Multiple advertisements are created in accordance with the advertising campaign. Performance metrics associated with each of the advertisements are measured and an advertisement having the highest performance metric is selected and run. In this way, owners of the advertising campaign ensure that only the best-performing advertisements are run, thereby ensuring that the owners realize the greatest profits. In other embodiments, poorly performing advertisements are not run, thereby allowing the owners to decrease any losses (cost to run the ad: profits). Embodiments of the present invention allow owners to easily monitor, manage, and create multiple advertisements run in accordance with an advertising campaign.

Embodiments of the present invention are able to be run on a variety of platforms including, but not limited to, a personal computer, a cellular telephone, an interactive television, an interactive kiosk, and a personal digital assistant.

It will further be appreciated that while the above discussion describes individual functions, some embodiments of the present invention are able to perform any combinations of functions to manage advertising campaigns. For example, some embodiments of the present invention are able to perform any combination of generating shadow campaigns, selecting advertisements based on performance metrics, pruning child nodes in a tree structure, running multiple advertisements concurrently or sequentially and collecting performance measurements, etc.

It will be readily apparent to one skilled in the art that other various modifications may be made to the embodiments without departing from the spirit and scope of the invention as defined by the appended claims.

We claim:

1. A method of managing an advertising campaign comprising:
a. selecting a parent advertising campaign; and
b. generating a child advertising campaign, wherein the child advertising campaign automatically inherits selected advertising criteria from the parent advertising campaign.

2. The method of claim 1, wherein the advertising criteria include at least one of a keyword, a creative, and a bid.

3. The method of claim 1, wherein changing a value of an advertising criterion in the parent advertising campaign automatically triggers a change in a value of the advertising criterion in the child advertising campaign.

4. The method of claim 1, further comprising setting the parent advertising campaign to trigger on a first type of keyword match and setting the child advertising campaign to trigger on a second type of keyword match.

5. The method of claim 4, wherein the each of the first type of keyword match and the second type of keyword match is one of an exact match, a phrase match, and a broad match.

6. The method of claim 1 wherein the parent advertising campaign is targeted to a first geographical location and the child advertising campaign is targeted to a second geographic location different from the first geographic location.

7. The method of claim 6, wherein a ratio between a value of an advertising criterion in the parent advertising campaign and a value of the advertising criterion in the child advertising campaign varies with a relationship between the first geographic location and the second geographic location.

8. A method of managing an advertising campaign comprising:
a. determining performance metrics for multiple advertisements in the advertising campaign; and
b. selecting an advertisement from the multiple advertisements based on its performance metric.

9. The method of claim 8, wherein each advertisement is formed by combining keywords, and creatives, wherein each keyword and each creative has an associated rating.

10. The method of claim 9, wherein the combining of keywords and creatives is determined by a fallback algorithm.

11. The method of claim 8, wherein the selected advertisement is selected based on a performance metric associated with its match type.

12. The method of claim 11, wherein the match type is one of an exact match, a phrase match, and a broad match.

13. The method of claim 11, further comprising adjusting a bid for a keyword based on the match type.

14. The method of claim 11, further comprising identifying new keywords to be added to the advertising campaign based on the match type.

15. The method of claim 11, further comprising determining which keywords from a plurality of keywords are to be run in a selected one of an exact match, a phrase match, and a broad match.

16. The method of claim 8, wherein each advertisement has a corresponding combination of creative, match type, landing page, and geographic target.

17. The method of claim 16, wherein the multiple advertisements are run concurrently.

18. The method of claim 17, wherein the multiple advertisements are run sequentially.

19. The method of claim 8, further comprising generating a plurality of combinations of advertising criteria for the multiple advertisements.

20. The method of claim 19, wherein a performance metric of the selected advertisement corresponds to a conversion rate.

21. The method of claim 19, further comprising adjusting bids based on performance metrics corresponding to each of the plurality of advertising criteria.

22. The method of claim 21, further comprising concurrently running the multiple advertisements each containing a keyword and determining a performance metric for each advertisement.

23. The method of claim 21, further comprising sequentially running the multiple advertisements each containing a keyword and determining a performance metric for each advertisement.

24. The method of claim 19, wherein the advertising criteria comprise any one or more of keywords, channels, syndications, creatives, match types, landing pages, geographic areas, days of the week, times of the day, age and gender.

25. The method of claim 21, wherein the multiple advertisements are related in a tree structure having a parent node and corresponding child nodes, wherein the parent node corresponds to an advertisement and the child nodes each corresponds to a match type for the advertisement of the parent node, the method further comprising pruning a child node from the tree if a performance metric corresponding to the parent node is below a predetermined threshold value.

26. The method of claim 19, wherein the advertising criteria correspond to geographic targets, the method further comprising determining a bid for each of the advertisements based on its geographic target and its corresponding performance metric.

27. The method of claim 8, further comprising:
a. determining sources of actions for each of the multiple advertisements; and
b. removing an advertisement from running at a source where a performance metric for the advertisement is below a predetermined threshold value.

28. The method of claim 27, wherein the sources of actions are identified by Internet Protocol addresses.

29. The method of claim 28, further comprising determining a referrer Uniform Resource Locator containing an Internet Protocol address.

30. The method of claim 8, further comprising:
a. specifying multiple performance goals for the multiple advertisements; and
b. adjusting bids for the multiple advertisements based on the multiple performance goals.

31. The method of claim 30, wherein the performance goals comprise a maximum total cost for the entire advertising campaign and a maximum cost for an advertisement in the advertising campaign.

32. The method of claim 8, further comprising:
a. determining a first keyword for the advertising campaign;
b. automatically determining a negative keyword of the first keyword; and
c. running an advertisement from the advertising campaign only if a document that triggers the advertising campaign contains the first keyword but does not contain the negative keyword.

33. The method of claim 32, wherein the negative keyword is determined from at least one of search terms and conversion data.

34. The method of claim 8, further comprising:
a. determining a sequence of clicks for accessing an item through an advertisement in the advertising campaign;
b. determining a value for the clicks in the sequence of clicks; and
c. allocating a performance metric to each of the clicks in the sequence of clicks.

35. The method of claim 34, wherein allocating performance metrics is based on any one or more of a time of a click, an order of a click in the sequence of clicks, and a number of advertisements clicked.

36. A shadow campaign system comprising:
a. means for generating a shadow campaign from a parent advertising campaign; and
b. a means for populating the shadow campaign with selected advertising criteria from the parent advertising campaign.

37. The system of claim 36, wherein the shadow campaign is a selected one of a conditional shadow campaign and an unconditional shadow campaign.

38. A system for managing an advertising campaign comprising:
a. a first module for generating multiple advertisements each containing a combination of advertising criteria from multiple combinations of advertising criteria; and
b. a performance calculator for calculating a performance of an advertisement from the multiple advertisements.

39. The system of claim 38, wherein the advertising criteria comprise any two or more of geographic locations, traffic sites, and match types.

40. The system of claim 38, wherein the advertising criteria comprise any two or more of creatives, landing pages, and geotargeting criteria.

41. The system of claim 38, wherein the advertising criteria comprise any two or more of keywords, channels, syndications, days of the week, times of the day, age, and gender.

42. The system of claim 38, further comprising a run module for running the generated multiple advertisements.

43. The system of claim 42, wherein the run module is configured to run the generated advertisements concurrently.

44. The system of claim 42, wherein the run module is configured to run the generated advertisements sequentially.

45. The system of claim 38, further comprising means for pruning advertisements that do not meet a threshold performance metric.

46. The system of claim 38, further comprising:
a. means for determining a purchase of an item from an advertisement in the advertising campaign; and
b. means for determining performance metrics for clicks in a sequence of clicks leading to the purchase.

47. The system of claim 46, wherein the means for determining performance metrics is configured to analyze a time of the clicks in the sequence of clicks, an order of a click in the sequence of clicks, and a number of clicks in the sequence of clicks.
